(19) United States
(12) Patent Application Publication
(10) Pub. No.: US 2017/0337677 A1
(43) Pub. Date: Nov. 23, 2017

(54) STATISTIC INFORMATION-BASED RAY CASTING ACCELERATION METHOD

(71) Applicant: Carestream Health, Inc., Rochester, NY (US)

(72) Inventor: Jiayin Chen, Shanghai (CN)

(21) Appl. No.: 15/177,626

(22) Filed: Jun. 9, 2016

Related U.S. Application Data
(60) Provisional application No. 62/340,078, filed on May 23, 2016.

(51) Int. Cl. G06T 7/00; G06T 15/08

(52) U.S. Cl. CPC G06T 7/0012; G06T 15/08; G06T 2207/30008; G06T 2207/10081

(57) ABSTRACT

A method for rendering a volume image, the method acquires a reconstructed volume image having a plurality of image voxels. The method defines a volume bounding box for the reconstructed volume image, wherein the bounding box is spatially subdivided into subspaces and wherein each image voxel is assigned to a spatially corresponding subspace. At least one mask is generated that characterizes the suitability of each of the subspaces for rendering. The method renders a 2D image from the reconstructed volume image using ray casting according to the generated mask.

### CROSS REFERENCE TO RELATED APPLICATIONS

This application claims the benefit of U.S. Provisional application U.S. Ser. No. 62/340,078, filed on May 23, 2016, entitled “STATISTIC INFORMATION-BASED RAY CASTING ACCELERATOR METHOD”, in the names of Jiayin Chen, which is incorporated herein by reference in its entirety.

### TECHNICAL FIELD

The disclosure relates generally to volume imaging and in particular to methods and apparatus for rendering volume image content for two-dimensional display.

### BACKGROUND

One advance made possible by radiographic digital imaging relates to the capability to reconstruct volume images from a sequence of 2-dimensional (2-D or 2D) projection images acquired in succession over a range of angles. Imaging modalities such as computed tomography (CT), including cone-beam computed tomography (CBCT) and multi-detector CT (MDCT), as well as related volume imaging technologies such as magneto-resonance imaging (MRI) now make it possible for a medical practitioner to obtain and visualize the full anatomy of a patient and to use this information for clinical and diagnostic assessment.

Volume imaging techniques involve the acquisition and processing of considerable amounts of image data, imposing formidable demands on computational, memory, and display resources, for tasks of reconstructing the volume data from 2-D data and for rendering the image content thus obtained to a display.

Rendering approaches that have been developed for this task include rasterization, mapping primitive image elements from their reconstructed 3-dimensional (3-D or 3D) coordinates to 2-D display screen space in order to show visible surface content with suitable color, texture, and shading. Conventionally executed by fast, multi-processor CPUs (central processing units), the rasterization task places high demands on computation speed and memory resources.

With the advent of dedicated Graphics Processing Units (GPUs) that are designed with many thousands of processors operating in parallel, advanced rendering methods have been developed, including ray casting. Ray casting techniques have been demonstrated to provide efficient ways to model 3-D features and to render these features at speeds that make rapid visualization and effects such as rotation, scaling, and other image manipulation possible, while accurately showing color, reflection, refraction, shading, texture, and other effects that enhance the 2-D visualization of volume content from a desired angle, with cross-sectional slice representation that shows inner structure in high detail.

While ray casting has shown considerable promise for supplanting earlier rasterization techniques, however, there remains considerable room for improvement. Even at the high speeds obtainable using high-powered GPU processing, there is a pressing need for achieving better response time and image quality.

### SUMMARY

Certain embodiments described herein address the need for an improved method for accelerating ray casting.

These aspects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to an embodiment of the present disclosure, there is provided a method for rendering a volume image, the method comprising: a) acquiring a reconstructed volume image having a plurality of image voxels; b) defining a volume bounding box for the reconstructed volume image, wherein the bounding box is spatially subdivided into a plurality of subspaces and wherein each image voxel is assigned to a spatially corresponding subspace; c) generating at least one mask that characterizes the suitability of each of the plurality of subspaces for rendering; and d) rendering a 2D image from the reconstructed volume image using ray casting according to the generated mask.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows, in schematic form, the scanning activity of a conventional CBCT imaging apparatus.

FIG. 2A is a simplified schematic showing a CBCT apparatus for extremity imaging of a subject.

FIG. 2B shows a top view of the FIG. 2A apparatus, with enclosure covers provided.

FIG. 2C is a top view schematic that shows intervals of a scanning sequence using the apparatus of FIG. 2A.

FIG. 3 is a simplified schematic diagram that shows the ray-tracing or ray-casting concept.

FIGS. 4A and 4B are simplified schematics that show a common acceleration mechanism for addressing the problem of volume rendering using pairs of entry points and exit points, useful in an embodiment.

FIGS. 5A and 5B show a schematic diagram that shows a conceptual modeling for mapping the volume with applied masks that can serve as an initial basis for execution of an embodiment.

FIG. 6 is a logic flow diagram that shows a procedural overview of the rendering pipeline for computational handling of the rendering task.

FIG. 7A is a schematic diagram that shows block processing for ray casting when using a binary mask to distinguish useful data from unneeded voxel data.

FIG. 7B is a schematic diagram that shows block processing for ray casting when using a statistical mask to distinguish useful from unneeded voxel data.

FIG. 8 is a logic flow diagram that shows a rendering scheme for ray casting acceleration using the mask-based approach.

FIG. 9 is a logic flow diagram that shows an alternate rendering scheme for ray casting acceleration using the mask-based approach.

FIG. 10A is an exemplary screen display that shows processing results for volume rendering when using conventional rendering techniques without using air masks.

FIG. 10B is an exemplary screen display that shows processing results for volume rendering when using conventional rendering techniques with an air mask.

FIG. 11 is an exemplary screen display that shows processing results for a knee joint using the rendering techniques of the present disclosure.

FIG. 12 is a schematic block diagram that shows various components of an exemplary computing-based device that can be used to implement the method of the present disclosure.

### DETAILED DESCRIPTION OF THE EMBODIMENTS

The following is a detailed description of the embodiments of the invention, reference being made to the drawings in which the same reference numerals identify the same elements of structure in each of the several figures.

Where they are used in the context of the present disclosure, the terms “first”, “second”, and so on, do not necessarily denote any ordinal, sequential, or priority relation, but are simply used to more clearly distinguish one step, element, or set of elements from another, unless specified otherwise.

As used herein, the term “energizable” relates to a device or set of components that perform an indicated function upon receiving power and, optionally, upon receiving an enabling signal.

In the context of the present disclosure, the phrase “in signal communication” indicates that two or more devices and/or components are capable of communicating with each other via signals that travel over some type of signal path. Signal communication may be wired or wireless. The signals may be communication, power, data, or energy signals. The signal paths may include physical, electrical, magnetic, electromagnetic, optical, wired, and/or wireless connections between the first device and/or component and second device and/or component. The signal paths may also include additional devices and/or components between the first device and/or component and second device and/or component.

In the context of the present disclosure, the term “subject” is used to describe the object that is imaged, such as the “subject patient”, for example. The term “rendering” has its conventional use, relating to the process of transforming a 3D volume image content to a 2D image and displaying, storing, or transmitting the rendered 2D image.

In the context of the present disclosure, “volume image content” describes the reconstructed image data for an imaged subject, generally stored as a set of voxels. Image display utilities use the 3-D or volume image content in order to display features within the volume, selecting specific voxels that represent the volume content for a particular slice or view of the imaged subject. Thus, volume image content is the body of resource information that is obtained from a CT, CBCT, MDCT, tomosynthesis, or other volume imaging reconstruction process and that can be used to generate depth visualizations of the imaged subject.

In the context of the present disclosure, the term “volume image” is synonymous with the terms “3 dimensional image” or “3D image”.

To describe an embodiment of the present disclosure in detail, the examples given herein focus on rendering CBCT images of human limbs and other extremities. However, these examples are considered to be illustrative and non-limiting. Embodiments of the present disclosure can be applied for rendering images obtained using numerous 3D imaging modalities, such as CT, MDCT, CBCT, tomosynthesis, dual energy CT, and spectral CT, for example.

Reference is made to U.S. Pat. No. 7,184,041 entitled “Block-based fragment filtration with feasible multi-GPU acceleration for real-time volume rendering on conventional personal computer” to Heng et al.

Reference is made to U.S. Pat. No. 7,154,500 entitled “Block-based fragment filtration with feasible multi-GPU acceleration for real-time volume rendering on conventional personal computer” to Heng et al.

Reference is made to US2005/0231503 entitled “Block-based fragment filtration with feasible multi-GPU acceleration for real-time volume rendering on conventional personal computer” by Heng et al.

Reference is made to US2005/0231504 entitled “Block-based fragment filtration with feasible multi-GPU acceleration for real-time volume rendering on conventional personal computer” by Heng et al.

Reference is made to WO2014/068400 entitled “On Demand Geometry and Acceleration Structure Creation” by Howson et al.

Reference is made to WO2006/122212 entitled “Statistical Rendering Acceleration” by Heirich et al.

Reference is made to U.S. Pat. No. 9,177,416 entitled “Space Skipping for Multi-Dimensional Image Rendering” to Sharp.

Reference is made to US2006/0147106 entitled “Using Temporal and Spatial Coherence to Accelerate Maximum/Minimum Intensity Projection” by Yang et al.

Reference is made to US2008/0231632 entitled “Accelerated Volume Image Rendering Pipeline Method and Apparatus” by Sulatycke.

Reference is made to US2009/0102842 entitled “Clipping Geometries in Ray-Casting” by Li.

In order to more fully appreciate the task of rendering 3D volume content to a 2D display, it is instructive to briefly review CBCT image capture and reconstruction. Then, in order to understand some of the techniques described herein for streamlining rendering calculations and improving the frame rate for extremity imaging, subsequent description gives an overview of a CBCT apparatus used for extremity imaging.

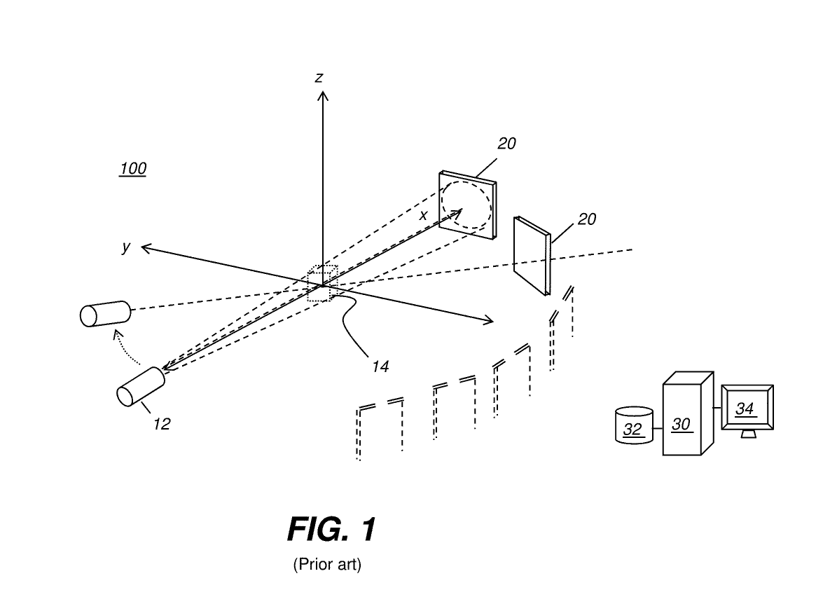

Referring to the perspective view of FIG. 1, there is shown, in schematic form and using enlarged distances for clarity of description, the activity of a conventional CBCT imaging apparatus 100 for obtaining, from a sequence of 2D radiographic projection images, 2D projection data that are used to reconstruct a 3D volume image of an object or volume of interest, also termed a subject 14 in the context of the present disclosure. Cone-beam radiation source 12 directs a cone of radiation toward subject 14, such as a patient or other subject. For a 3D or volume imaging system, the field of view (FOV) of the imaging apparatus is the subject volume that is defined by the portion of the radiation cone or field that impinges on a detector for each projection image. A sequence of projection images of the field of view is obtained in rapid succession at varying angles about the subject, such as one image at each 1-degree angle increment in a 200-degree orbit. X-ray digital radiation (DR) detector 20 is moved to different imaging positions about subject 14 in concert with corresponding movement of radiation source 12. FIG. 1 shows a representative sampling of DR detector 20 positions to illustrate schematically how projection data are obtained relative to the position of subject 14. Once the needed 2D projection images are captured in this sequence, a suitable imaging algorithm, such as filtered back projection (FBP) or other conventional technique, is used for reconstructing the 3D volume image. Image acquisition and program execution are performed by a computer 30 or by a networked group of computers 30 that are in image data communication with DR detector 20. Image processing and storage is performed using a computer-accessible memory 32. The 3D volume image can be rendered for presentation on a display 34.

Embodiments of the present invention can be readily adapted to the particular geometry of the CBCT or other volume imaging apparatus. In particular, an extremity imaging apparatus can generate volume images suitable for application of methods described herein.

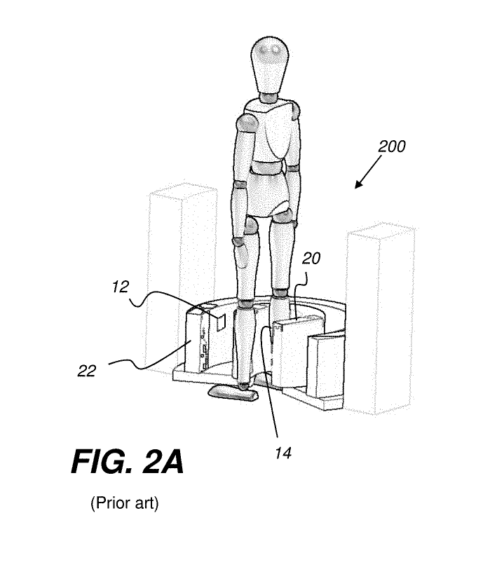

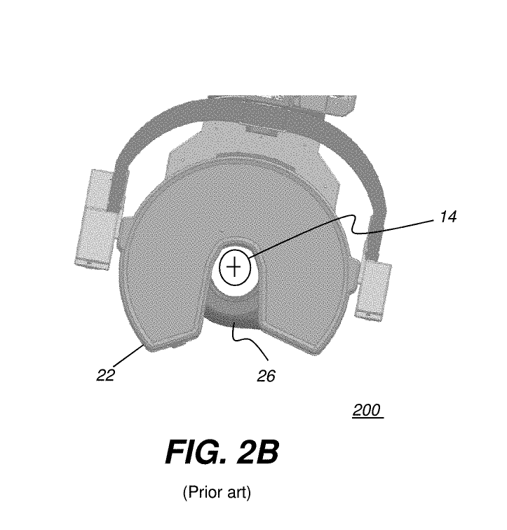

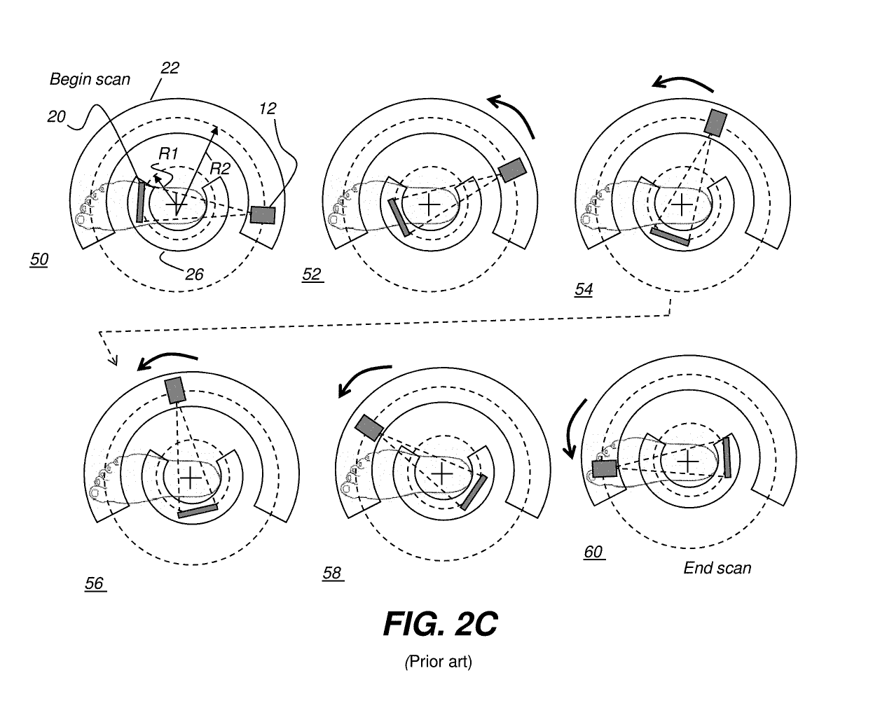

FIG. 2A shows, in simplified schematic form, a CBCT apparatus 200 for extremity imaging of a subject 14, such as a leg as shown in this example. FIG. 2B shows a top view, with covers provided. FIG. 2C is a top view schematic that shows intervals of a scanning sequence, with successive angular positions 50, 52, 54, 56, 58, and 60 during which source 12 and detector 20 orbit subject 14 to obtain the plurality of projection images used for volume reconstruction as depicted in FIG. 1. Detector 20 orbits subject 14 at a radius R1. Source 12 orbits subject 14 at a radius R2. An enclosure 22 can have a door 26 that provides a transport path for the detector 20.

As shown in FIGS. 2A-2C, an extremity imaging apparatus has an arrangement of components that is particularly well-suited for imaging a portion of an object that is generally cylindrical. Ray casting embodiments described herein can take advantage of knowledge of the general shape and aspect ratio of the imaging apparatus in order to streamline the rendering process for generating a 2D display from an extremity apparatus having the described characteristics.

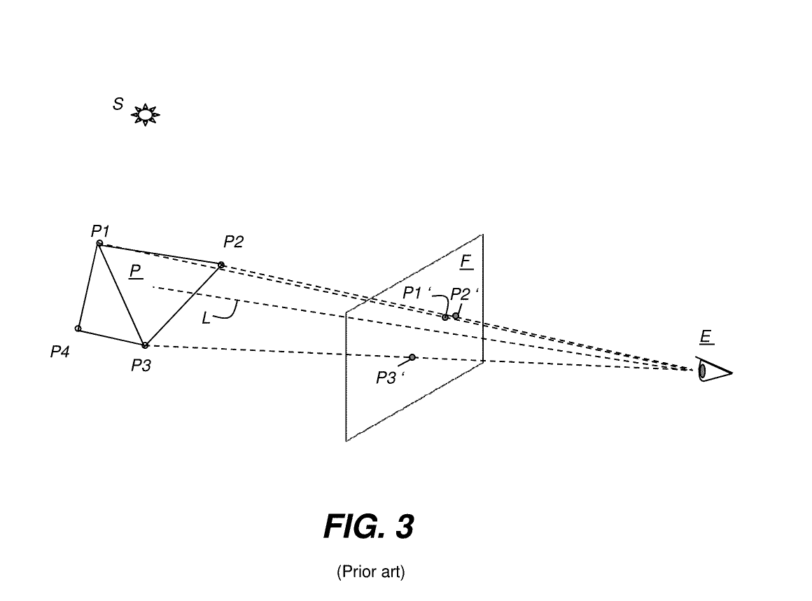

FIG. 3 shows the ray-casting or ray tracing concept in simplified schematic form. A geometric primitive P from a 3D object in an object scene or volume, shown as a prism in this example, is to be represented in a 2D frame F, such as a computer display screen. This requires mapping 3D vertex points P1, P2, P3 to corresponding 2D pixels P1′, P2′, and P3′ on frame F. A vantage point for the view is designated, typically the position of the viewer's eye E along a predetermined line of sight L. Ray casting uses the conceptual model of lines traced from the vantage point at eye E, through frame F, and to points P1, P2, P3 on the 3D object in the volume that is the object scene.

The process shown for a handful of pixels in FIG. 3 repeats for each of the thousands of pixels of the frame F, presenting a formidable computational task. In order to successfully render the object scene, having thousands of pixels, thousands of rays must be traced or cast toward points on the prism or other object in the object field. The rendering task also requires detecting what points are obscured, as shown by a fourth point P4 of the object that is not visible within the given view of frame F. The simplified transformation quickly becomes even more complex when the task requires faithful rendering of surfaces, texture, color, effects of light from a source S such as reflection, refraction, absorption, shadows, and other effects that make the rendered scene content realistic.

Aspects of the imaged subject itself also contribute to the computational burden for ray casting. With volume data reconstructed from a CBCT scan, such as the anatomy as described with reference to FIGS. 1-2C, the viewed object can be considerably complex, particularly for images intended for use as diagnostic tools. Thus, the ray casting task, although conceptually straightforward for simple geometric primitives, quickly becomes highly computationally intensive for any real-world image. It is thus clear that among challenges with ray casting is the considerable demand placed on computational and memory resources.

In response to the need for rapid visualization of 3D objects, various optimization techniques have been proposed for advancing the speed and efficiency of ray casting. Termed acceleration techniques, these approaches provide mechanisms for modeling the 3D volume data in ways that speed the ray casting process. Among tactics used by acceleration techniques include ways to identify procedural short-cuts and eliminate computational redundancies to reduce the number of unnecessary steps for rendering. Acceleration methods for dealing with these challenges have included:

(i) use of blocked data structures to help filter out useless or unneeded data, based on factors such as scalar field and view-dependent occlusion;

(ii) use of hierarchical data structures for adaptive and interactive optimization;

(iii) use of data structures such as oct-tree structure for volume data representation, with accompanying statistical analysis;

(iv) ray-clipping using techniques to skip rapidly through air and other unused space to determine clipping positions, such as using volume pyramid techniques.

The above (i)-(iv) listing is not exhaustive, as developers have tried numerous approaches in order to make the ray casting technique less computationally demanding. A number of these approaches require considerable CPU resources for data preparation and pre-processing. Even with advances in GPU design and capability, conventional methods for ray casting are characterized by requirements for considerable data overhead, processing time, and compromised image quality, among other problems.

Embodiments of the present disclosure address ray casting using a data model that provides both system-based and statistical methods for quickly identifying voxels that can be eliminated from further processing because they represent air or have content that is of no interest for the desired rendering.

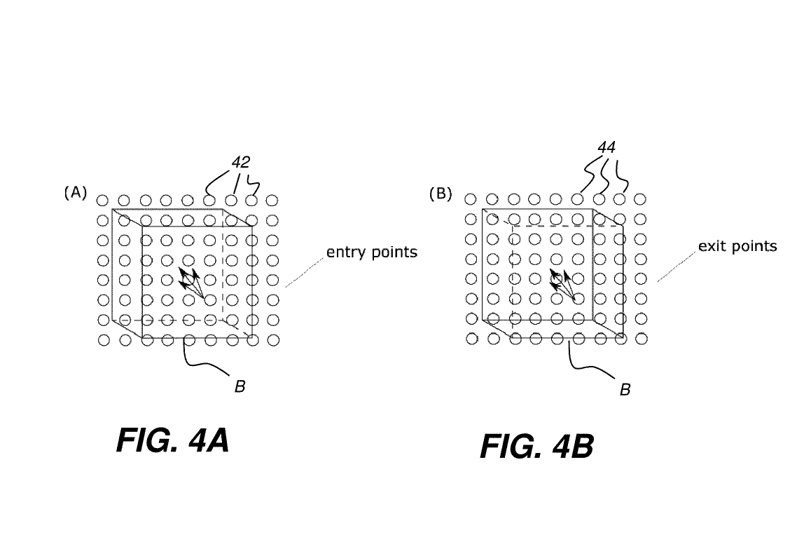

FIGS. 4A and 4B show, in schematic form, an acceleration mechanism for addressing the problem of volume rendering by defining a volume bounding box B for a reconstructed image to be rendered and calculating pairs of entry points 42 and exit points 44, useful in an embodiment. This mechanism is implemented as a step in volume rendering with modern GPU hardware and using the corresponding OpenGL pipeline, familiar to those skilled in the ray casting art. In this mechanism, the point positions of the volume bounding box are captured and stored in two frame-buffer objects (FBOs) of the GPU. These objects are later called for fast acquisition of useful ray positions. Because the ray positions that extend outside the volume shape are not considered, the time cost using this modeling is efficient, so that only the data locations of possible utility for rendering are addressed.

Embodiments of the present disclosure further eliminate data that is not needed for rendering using one of a number of masking schemes. A mask is generated that characterizes the suitability of subspaces of the volume image for rendering. Various types of helper masks can be used to help to distinguish useful data for rendering the desired image content from useless or unneeded data that lies in spatial regions of the reconstructed volume data that are of no interest. For this processing, the reconstructed volume data, such as the CBCT reconstructed image voxels, can be considered the superset of data that is available for use in any rendering process. The helper mask of the present disclosure provides a mechanism that speeds rendering by identifying only the subset of this superset containing voxels that are of interest for a particular rendering operation. Groups of unneeded or useless voxels are thereby “masked out” of the ray casting process. Masking voxels that are of no interest from the subset of voxels that is rendered dramatically reduces the processing and memory overhead that would otherwise be necessary in ray casting. The helper mask arrangement can store statistical data extracted from the Hounsfield unit (HU) values calculated for voxels within a brick or block 40 that is a subspace of the volume bounding box. The terms “brick” and “block” are used equivalently herein to describe the basic subspace unit for the volume bounding box that encompasses the volume image. The block can be a rectangular subspace or can have some other unit shape that allows each voxel of the volume to be assigned to a corresponding unit subspace according to its spatial condition. Exemplary statistical data can include, for example, mean (average), median, mode, variance, standard deviation, maxima and minima for the corresponding voxels.

In order to efficiently generate a mask so that it can be both quickly prepared and easily used in the rendering process, embodiments of the present disclosure utilize a GPU compute shader, using addressing and processing techniques familiar to those skilled in GPU data manipulation and architecture.

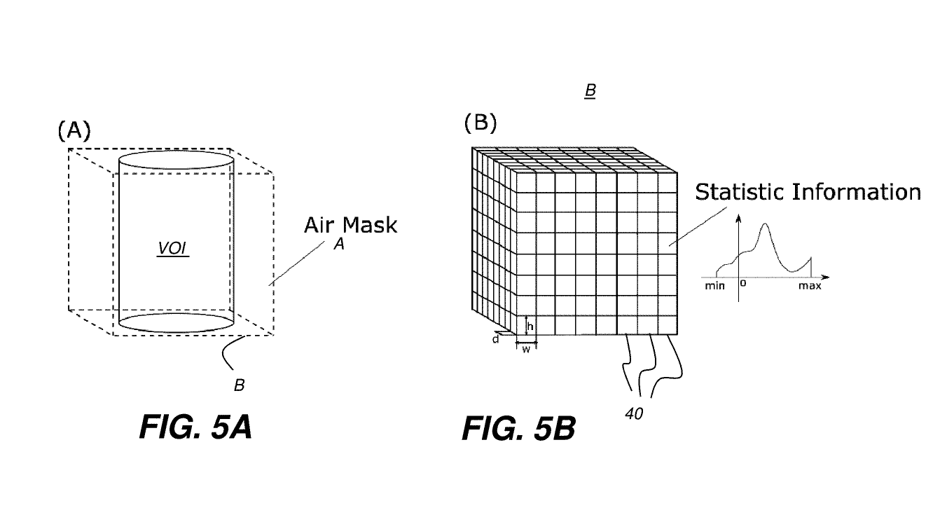

Referring to FIGS. 5A and 5B, there is shown a schematic representation for two of the types of masks that can be generated and used as helper masks for characterizing the suitability of each of the plurality of subspaces of the reconstructed volume for rendering, streamlining the rendering process by reducing the processing overhead for ray casting, using the ray casting acceleration techniques of the present disclosure. At FIG. 5A is shown the concept of an air mask A that can be applied to the reconstructed volume data to define a volume of interest VOI and to effectively remove, from ray casting processing, regions outside the VOI that are considered to be air.

The air mask A can use a priori knowledge of imaging system parameters. For the extremity imaging apparatus 200 shown in FIGS. 2A-2C, for example, the conventional bounding box B that is familiarly used to represent the reconstructed volume and that is assumed as input to the GPU volume rendering scheme does not accurately approximate the actual cylindrical shape of the imaged field.

FIG. 5B shows an alternate masking approach, illustrated as part (B), that can be used in conjunction with the air mask A or separately. The method shown in FIG. 5B considers statistical values calculated over different segments or subspaces of the volume bounding box B to characterize the suitability of each of the segments or subspaces for rendering. This processing, for example, can determine which segments should be considered in ray casting and which can be ignored or masked. For this method, bounding box B is considered as a 3D arrangement, subdivided into blocks or bricks 40 as basic unit subspaces. Statistical information is calculated for the volume data associated with the volume data within each block 40. Statistical information obtained from each block enables quick characterization of the block, so that unneeded blocks can be rapidly identified and removed from the ray casting processing.

For both the air mask of FIG. 5A and the statistically determined mask of FIG. 5B, mask resolution corresponds to block size. The air mask shown in FIG. 5A can be used in binary fashion, so that any voxel in the block is either used in ray casting or ignored in ray casting. The helper mask shown in FIG. 5B is not used in binary fashion, but is used to store statistical information about voxels within the block for use during the rendering process.

Embodiments of the present disclosure can employ the blocked volume bounding box data structure shown in FIG. 5B to store the statistical data for acceleration of volume rendering. Suitable statistic information such as histogram distribution, maximum value, minimum value, mean, median, mode, variance, standard deviation, and other statistical characteristics of the data for voxels within the block can be computed and stored. A particular implementation could use more than one mask; however, it is generally advantageous for the masks to share block 40 dimensions. The statistical information is compared against one or more threshold values determined by a transfer function provided in the logic processing, as described subsequently.

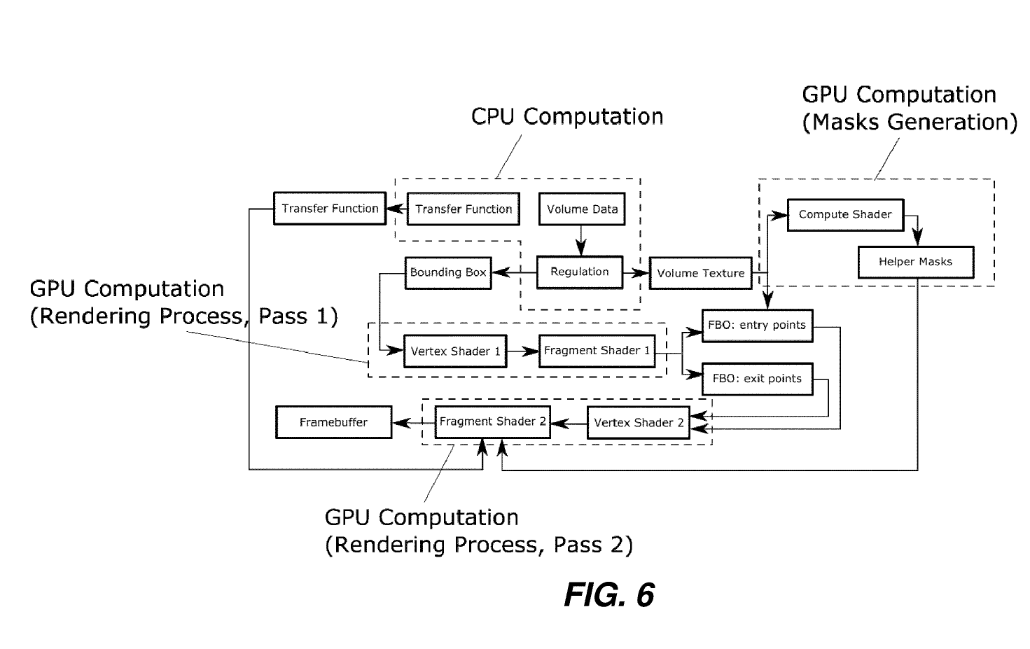

FIG. 6 is a logic flow diagram that shows a procedural overview of the rendering process executed by a system CPU and GPU. As FIG. 6 shows, the rendering pipeline of the method described by the invention has basically three phases:

(i) CPU pre-processing, shown as the CPU Computation phase;

(ii) GPU pre-processing, shown as the Masks Generation phase; and

(iii) main rendering procedure, shown as Rendering Process, Pass1 and Pass 2.

The rendering process begins with volume data, such as 3D volume data reconstructed from a CBCT imaging apparatus as described with reference to FIGS. 1-2C. CPU pre-processing (i) deals with regulation of volume data and provides definition of a volume bounding box and volume texture data. CPU pre-processing also generates a transfer function and its corresponding lookup table. The transfer function from the CPU generally provides a mapping of the volume data Hounsfield Unit (HU) values to color and opacity data structures used in subsequent GPU processing. Conventional 2D transfer functions (2DTFs) are based on data intensities and gradient magnitude for the volume data. An operator selection or other setting can determine the setting of variables for a particular transfer function. This, in turn, can determine mask parameters, such as whether or not a particular block is masked and thus removed from ray casting computation.

GPU pre-processing (ii) deals with the generation of assistant or supporting data, termed helper masks, such as the air mask and statistical mask using block segmentation of the volume as described with reference to FIGS. 5A-5B. The compute shader generates helper masks. Helper masks generated by the GPU are used by a fragment shader in the second rendering pass. A helper mask is represented as a volume with reduced resolution when compared to voxel resolution, thus contributing little to the data overhead.

The main rendering procedure (iii) is a two-pass rendering, as shown. A first pass captures the entry/exit points within the volume bounding box, as was previously described with reference to FIGS. 4A and 4B. A second pass performs a ray-casting algorithm, based on transfer function values and using the helper masks provided. Conveniently, the output of the rendering pipeline can be stored as a GPU frame buffer object (FBO).

Embodiments of the present disclosure provide innovative improvement to earlier rendering methods largely by virtue of the GPU pre-processing procedure (ii) and the main rendering procedure in (iii), particularly with respect to Pass 2 of the procedure.

The GPU processing uses the bounding box defined to encompass the volume data, then directs this structure to the first-pass rendering process that executes vertex shader 1 and fragment shader 1. The volume texture and fragment shader 1 output then defines FBO entry and exit points, as described previously with respect to FIGS. 4A and 4B.

The second-pass rendering process then uses the identified entry and exit points and directs the data to vertex shader 2 and fragment shader 2 processes. Fragment shader 2 takes the transfer function and helper masks and applies these structures to the volume data during ray casting. Output is directed to the frame buffer for rendering.

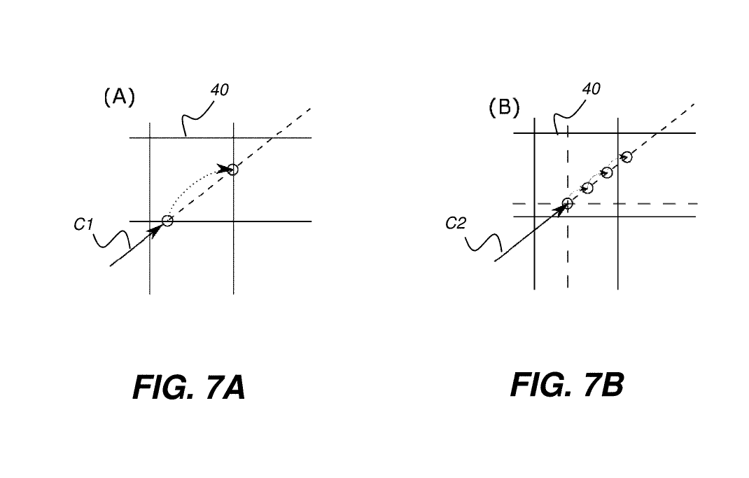

The acceleration mechanism that is developed and used herein takes advantage of the block structure and employs space skipping during ray casting, as shown for the helper mask arrangements of FIGS. 5A-5B, parts (A) and (B) in the corresponding diagrams of FIGS. 7A and 7B. When the current ray position is within a block 40 that is determined to have only useless data, according to an air mask A of FIG. 5A, the ray can immediately skip forward to the next block on its path as shown for a ray C1 in FIG. 7A. This skipping step eliminates the need for further ray casting calculation in that block 40. Otherwise, the ray can propagate with a standard step size. FIG. 7B shows standard step size used for calculation with respect to a ray C2. For the mask arrangement of FIG. 5B, calculation at each step can be skipped or can be simply executed quickly where the statistical helper mask indicates that block 40 contains unneeded information.

Embodiments of the present disclosure can use either of the block traversal methods shown in FIG. 7A or 7B. The block skipping shown in FIG. 7A is conceptually simpler, but can require altering of the normal ray casting process. The skipping method shown in FIG. 7B executes each of the standard sampling steps, but can move more quickly, since only basic arithmetic operations are executed at each step.

Embodiments of the present method represent an improvement over conventional block-skipping techniques in a number of ways.

(i) The method described herein uses statistic data instead of scalar data in a blocked data structure to help eliminate unneeded data from computation;

(ii) The method described herein can employ multiple masks to achieve tailored acceleration with respect to a specific application;

(iii) The method described herein shares block 40 size among the masks, taking advantage of GPU parallel computation so that the data and computational overhead can be negligible;

(iv) The method of the present disclosure uses the GPU “compute shader” to generate the helper masks, which significantly minimizes the processing time before rendering.

### Air Mask Generation

Referring again to the extremity imaging apparatus 200 shown in FIGS. 2A-2C, the VOI is generally cylindrical in shape. Thus, for a leg, for example, a first approximation of the VOI is a cylinder, as suggested in FIG. 5A part (A).

The air mask generation method for the extremity imaging apparatus 200 uses this type of a priori information about the shape of the image field of the imaging apparatus. Knowing the system geometry allows the system to define the volume region outside the cylindrical imaged region (that is, outside the VOI) as air and forms a mask suitably shaped to eliminate the corresponding “Air” data from the volume that is used for ray casting and rendering calculation.

Using the air mask technique for the imaging apparatus described in FIGS. 2A-2C, the properties of the volume data that lies outside the imaging cylinder can be readily eliminated from consideration for rendering. Thus, for at least this initial processing step, this tailored design helps to optimize the performance of a specific imaging apparatus for extremity imaging. In other words, the acceleration method in this disclosure considers the design of the imaging apparatus for extremity imaging and supports tailored design, using a priori knowledge of system behavior to improve rendering efficiency.

The statistic information in the blocks 40, as represented in FIG. 5B part (B), is more closely related to the transfer function generated by the CPU and the current range of Hounsfield Unit (HU) values in the rendering process. That is, parameters of the transfer function that is selected for rendering determine factors such as threshold levels for statistical values, wherein comparison against the threshold determines whether or not the block contains useful data for ray casting. Thus, using statistical masking and varying threshold values according to the transfer function, the processor can quickly determine how ray-casting processing of the block should continue.

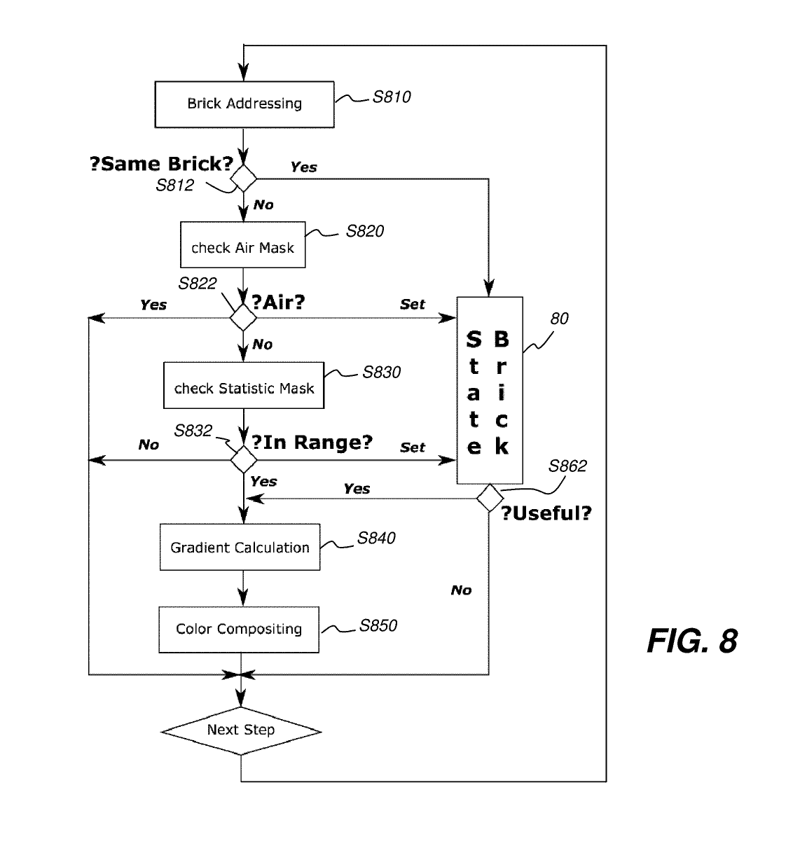

To handle the data exclusion operation, the acceleration method uses one or more masks. The logic flow diagram of FIG. 8 shows a rendering scheme for ray casting acceleration using the mask-based approach with full block 40 skipping as shown in FIG. 7A to process each block 40 in the volume image and maintain a brick stack 80 that stores masking results for each block or brick.

To begin this processing, a block addressing step S810 addresses and identifies a single block 40 within the bounding box B.

Subsequent steps in this sequence are as follows:

(i) A decision step S812 determines whether or not the same block or brick has just been processed. If so, this step checks and updates a brick stack 80 accordingly. Brick stack 80 can store mask status for each block 40 of the volume.

(ii) An air mask application step S820 checks whether or not the block lies within the defined air mask for the system and updates the brick stack 80 accordingly. If the block 40 is excluded by the air mask, the process continues without further block processing. If the block 40 is not excluded by the air mask, as determined by a decision step S822, a statistic mask application step S830 executes.

(iii) A decision step S832 executes to update the brick stack 80 according to statistic mask results.

(iv) If the block 40 contains useful data, ray casting can proceed for the block. A gradient calculation step S840 executes, along with a color compositing step S850 for rendering of the block content.

(v) A decision step S862 ignores the block for ray casting if the mask checks of steps S820 and S830 do not indicate useful data.

The process of FIG. 8 repeats for subsequent blocks.

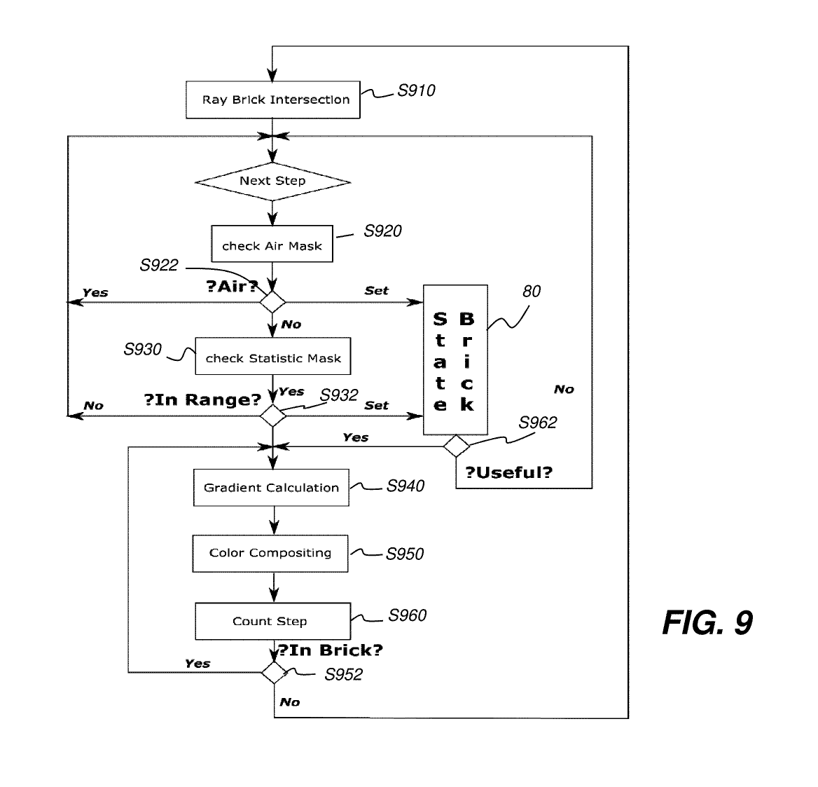

The logic flow diagram of FIG. 9 shows an alternate rendering scheme for ray casting acceleration using the mask-based approach, proceeding with standard step size as described with reference to FIG. 7B to process each block 40 in the volume image.

Steps in this alternate sequence are as follows:

(i) An intersection step S910 detects ray intersection with a block.

(ii) An air mask application step S920 checks whether or not the block lies within the defined air mask for the system and updates the brick stack 80. If the block 40 is not excluded by the air mask, as determined by a decision step S922, a statistic mask application step S930 executes.

(iii) A decision step S932 executes to update the brick stack 80 according to statistical mask results.

(iv) If the block 40 contains useful data, ray casting can proceed for the block. (v) A gradient calculation step S940 executes, along with a color compositing step S950 for rendering of the block content.

(vi) A count step S960 provides a count value for ray progression in steps within the block.

(vii) A decision step S952 determines whether or not the ray is still within the same block.

(viii) A decision step S962 ignores the block for ray casting if the mask checks for steps S920 and S930 do not indicate useful data within the block.

The process repeats for subsequent counts of steps within the block.

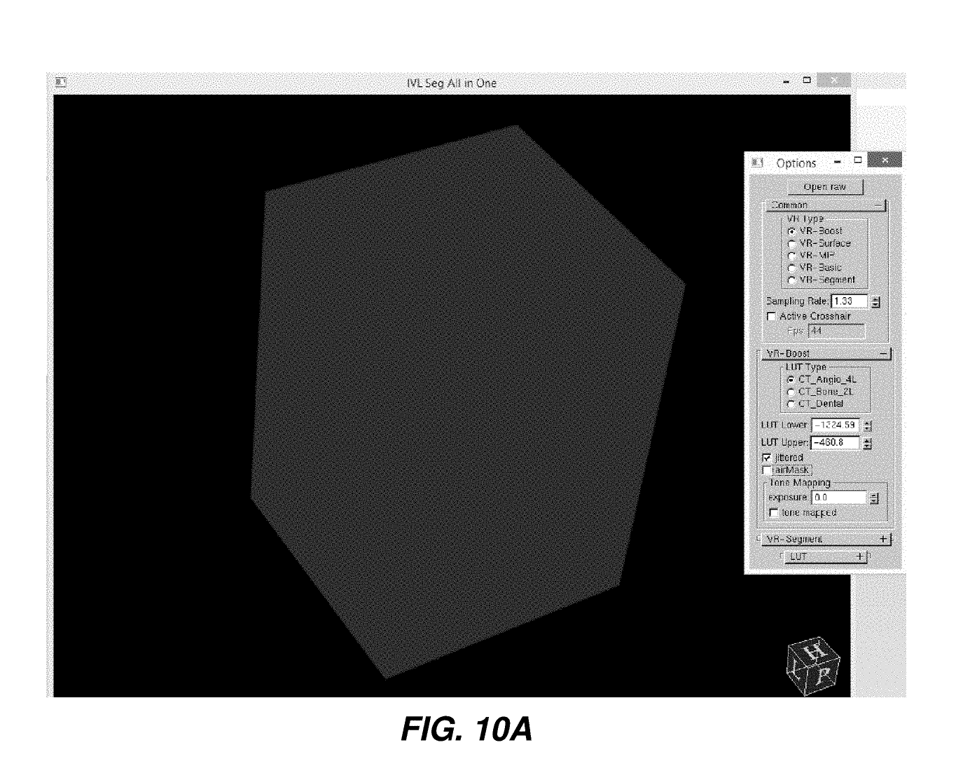

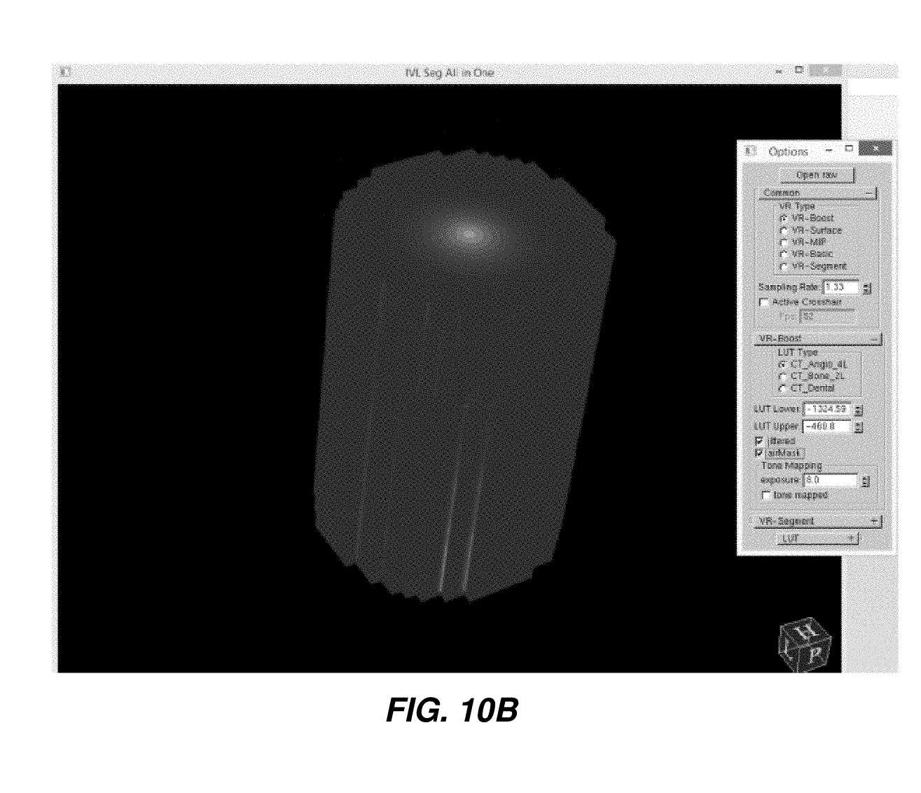

FIG. 10A shows processing results for volume rendering of a VOI with very low look-up table values in the transfer function. No air mask is applied. The statistically based mask is not applied.

FIG. 10B shows processing results for rendering the VOI when using rendering techniques with air masks. The same transfer functions used for FIG. 10A are applied. Note that the cylindrical shape indicates the valid imaging region when using the extremity imaging apparatus 200 described with reference to FIGS. 2A-2C. The jagged silhouette shows the use of “Blocks” as the basic data structure employed, following mask application.

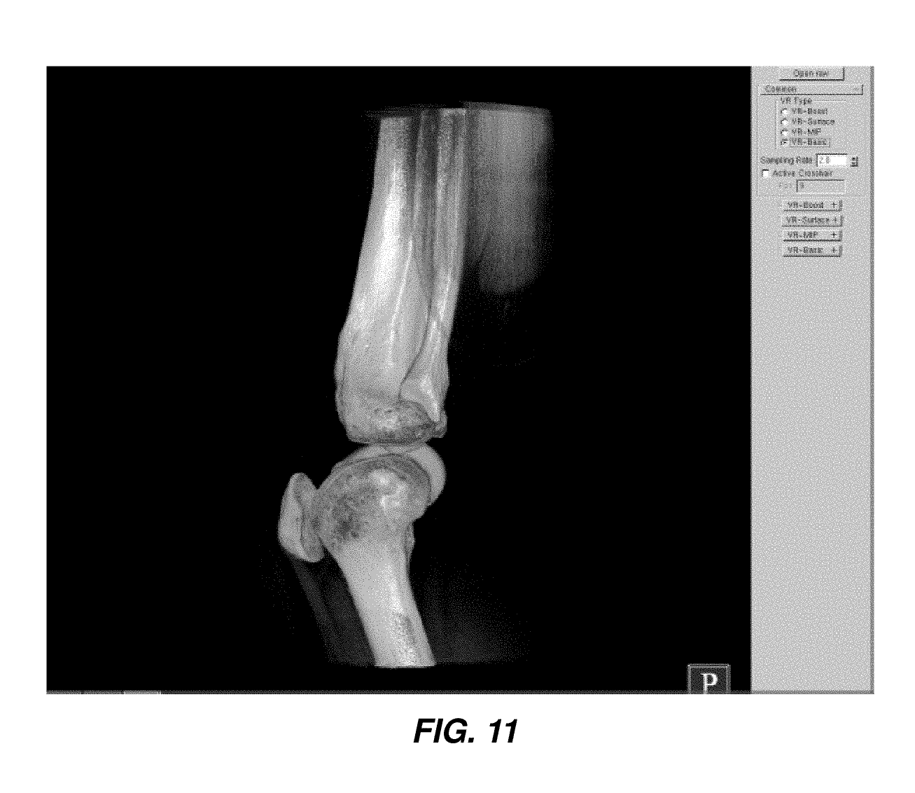

One advantage of the method of the present disclosure relates to a dramatic increase in processing speed, as shown in a higher frame rate. The example knee joint shown in FIG. 11 shows, for the same image content of FIGS. 10A and 10B but with a more suitable transfer function, rendering results achievable with a frame rate that is more than twice the same rate achieved using conventional techniques.

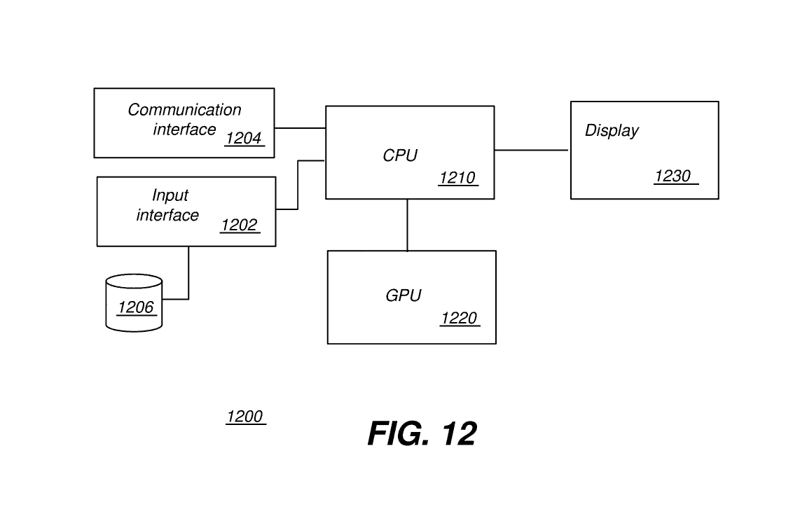

FIG. 12 is a schematic block diagram that shows various components of an exemplary computing-based device 1200 that may be implemented as any form of a computing and/or electronic device, and in which embodiments of image rendering using an embodiment of the present disclosure can be implemented.

The computing-based device 1200 comprises one or more input interfaces 1202 of any suitable type for receiving user input, such as volume images from a database or storage device 1206 for rendering. The device also has a communication interface 1204 for communicating with one or more communication networks, such as the internet (e.g. using internet protocol (IP)) or a local network. The communication interface 1204 can also be used to communicate with one or more external computing devices, and with databases, such as a medical database or other storage devices 1206.

Computing-based device 1200 can have one or more control logic processors 1210 which may be microprocessors, controllers or any other suitable type of processors for processing computing executable instructions to control the operation of the device in order to perform image rendering. The device also comprises one or more graphics processing units GPU 1220 for graphics rendering. Platform software comprising an operating system or any other suitable platform software may be provided at the computing-based device 1200 to enable application software to be executed on the device. A display 1230 provides rendered display output.

Consistent with one embodiment, the present invention utilizes a computer program with stored instructions that control system functions for image acquisition and image data processing for image data that is stored and accessed from an electronic memory. As can be appreciated by those skilled in the image processing arts, a computer program of an embodiment of the present invention can be utilized by a suitable, general-purpose computer system, such as a personal computer or workstation that acts as an image processor, when provided with a suitable software program so that the processor operates to acquire, process, transmit, store, and display data as described herein. Many other types of computer systems architectures can be used to execute the computer program of the present invention, including an arrangement of networked processors, for example.

The computer program for performing the method of the present invention may be stored in a computer readable storage medium. This medium may comprise, for example; magnetic storage media such as a magnetic disk such as a hard drive or removable device or magnetic tape; optical storage media such as an optical disc, optical tape, or machine readable optical encoding; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the internet or other network or communication medium. Those skilled in the image data processing arts will further readily recognize that the equivalent of such a computer program product may also be constructed in hardware.

It is noted that the term “memory”, equivalent to “computer-accessible memory” in the context of the present disclosure, can refer to any type of temporary or more enduring data storage workspace used for storing and operating upon image data and accessible to a computer system, including a database. The memory could be non-volatile, using, for example, a long-term storage medium such as magnetic or optical storage. Alternately, the memory could be of a more volatile nature, using an electronic circuit, such as random-access memory (RAM) that is used as a temporary buffer or workspace by a microprocessor or other control logic processor device. Display data, for example, is typically stored in a temporary storage buffer that is directly associated with a display device and is periodically refreshed as needed in order to provide displayed data. This temporary storage buffer can also be considered to be a memory, as the term is used in the present disclosure. Memory is also used as the data workspace for executing and storing intermediate and final results of calculations and other processing. Computer-accessible memory can be volatile, non-volatile, or a hybrid combination of volatile and non-volatile types.

It is understood that the computer program product of the present invention may make use of various image manipulation algorithms and processes that are well known. It will be further understood that the computer program product embodiment of the present invention may embody algorithms and processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with the computer program product of the present invention, are not specifically shown or described herein and may be selected from such algorithms, systems, hardware, components and elements known in the art.

The invention has been described in detail, and may have been described with particular reference to a suitable or presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for rendering a volume image, the method comprising:
acquiring a reconstructed volume image having a plurality of image voxels;
defining a volume bounding box for the reconstructed volume image, wherein the bounding box is spatially subdivided into a plurality of subspaces and wherein each image voxel is assigned to a spatially corresponding subspace;
generating at least one mask that characterizes the suitability of each of the plurality of subspaces for rendering;
rendering a 2D image from the reconstructed volume image using ray casting according to the generated mask; and
displaying, storing, or transmitting the rendered 2D image.

2. The method of claim 1 wherein generating the at least one mask comprises forming an air mask that conforms to the shape of an imaged field for a cone beam computed tomography apparatus.

3. The method of claim 1 wherein generating the at least one mask comprises computing at least one statistical value within one or more of the subspaces.

4. The method of claim 3 wherein generating the at least one mask is conditioned by a transfer function that maps x-ray density values to color or opacity.

5. The method of claim 3 wherein the at least one statistical value is a mean or median data value.

6. The method of claim 3 wherein the at least one statistical value is a variance or standard deviation.

7. The method of claim 1 wherein acquiring a reconstructed volume image comprises acquiring a volume image from a CBCT apparatus.

8. The method of claim 1 wherein the subspaces are rectangular blocks.

9. A method for rendering an image, the method comprising:
acquiring a reconstructed volume image having a plurality of image voxels;
defining a volume bounding box for the reconstructed volume image, wherein the bounding box is spatially subdivided into a plurality of subspaces and wherein each image voxel is assigned to a spatially corresponding subspace;
generating at least one air mask that models the shape of an imaged field for an imaging apparatus and that identifies at least a first subspace of the plurality of subspaces as useful and at least a second subspace of the plurality of subspaces as unneeded for rendering according to air content; and
rendering the image using ray casting, wherein the ray casting ignores data from at least the second subspace.

10. A method for rendering an image, the method comprising:
acquiring a reconstructed volume image having a plurality of image voxels;
defining a volume bounding box for the reconstructed volume image, wherein the bounding box is spatially subdivided into a plurality of subspaces and wherein each image voxel is assigned to a spatially corresponding subspace;
generating at least one statistical mask that identifies at least a first of the plurality of subspaces as useful and at least a second subspace of the plurality of subspaces as unneeded for rendering according to one or more statistical values computed for the at least the first and second subspaces and according to a transfer function that maps Hounsfield values to color or opacity data values; and
rendering the image using ray casting, wherein the ray casting ignores data from the at least the second subspace.

11. The method of claim 10 further comprising forming an air mask that models the shape of an imaged field for a cone beam computed tomography apparatus, wherein the air mask and the at least one statistical mask have the same subspace resolution.

12. An imaging apparatus comprising:
a central processing unit having a communication interface and an input interface and in signal communication with a graphics processing unit; and
a display in signal communication with the central processing unit, wherein the graphics processing unit is configured to receive a volume image from the central processing unit and is programmed with stored instructions to:
(i) spatially associate each voxel element of the volume image to a corresponding one of a plurality of subspaces defined within a volume bounding box;
(ii) generate at least one mask that characterizes each of the plurality of subspaces as useful or as unneeded for rendering; and
(iii) form the rendered image using ray casting, wherein the ray casting discards data from any of the masked unneeded subspaces.
